(19) United States
(12) Patent Application Publication
(10) Pub. No.: US 2017/0014005 A1
(43) Pub. Date: Jan. 19, 2017

(54) Accelerator Foam Generating Device

(71) Applicant: Greg A. Blanchat, Harper, KS (US)

(72) Inventor: Greg A. Blanchat, Harper, KS (US)

(21) Appl. No.: 14/802,424

(22) Filed: Jul. 17, 2015

(51) Int. Cl. A47K 5/14; B05B 7/00

(52) U.S. Cl. CPC A47K 5/14; B05B 7/0025

(57) ABSTRACT

An air and water/soap concentrate mixing device which creates high quality compressed air foam without restricting the flow of liquid through the apparatus. The device consists of three water/soap concentrate chambers, an air manifold and a central air diffuser tube. Water/soap concentrate flow is increased through the device from the entry chamber (first) thru the acceleration (second) chambers. Upon entering the deceleration (third) chamber, the water/soap concentrate perimeter is laced with pressurized air from the air manifold wrapping the acceleration chamber. At the same time, pressurized air is also diffused and embedded in the center of the water/soap concentrate flow via the air diffuser tube. As the accelerated water/soap concentrate enters the deceleration chamber, the flow is dramatically decreased. This slowing of the water/soap concentrate and the introduction of pressurized air causes a pressure volatility and turbulence inside the deceleration chamber allowing the pressures of the water/soap concentrate and air to equalize and mix creating foam bubbles. The device is also capable of flowing plain water or water/soap concentrate through the device if the pressurized air system or soap injection system is deactivated.

### DETAILED DESCRIPTION OF THE INVENTION

The present mixing device has three primary chambers—the water/soap concentrate entry chamber 10, acceleration chamber 20 and deceleration chamber 30. These chambers, shown in FIG. 1, are assembled together in this respective order. In addition, an air manifold 50 is wrapped around the acceleration chamber 20 and an air diffuser tube 40 is assembled inside the center of the acceleration chamber 20. These chambers are preferably welded together for strength and leak protection but may be connected by other means. They are preferably built from stainless steel for durability and corrosion resistance but alternative materials with or without coatings which achieve similar strength and corrosion resistance can be used. Such materials could include brass and high strength plastics.

The entry chamber 10 and deceleration chamber 30 are preferably sized such that their inlet and outlet, respectively, is sized to accommodate the size of piping used in the particular firefighting apparatus. Common piping sizes used can span from 1″ to 6″, depending on the application requirements. The size of the entire device may be adjusted to accommodate the piping size, flow and pressure requirements in a particular application. The cross-sectional shape of the device chambers is not limited to a circle as shown in the attached drawings but may be an oval, square, rectangle, etc. as is determined best for the application. The entry chamber 10 inlet and deceleration chamber 30 outlet can be preferably setup to accommodate a wide variety of connection types, depending on the application requirements, which may include welded, thread or Victaulic connections. Additionally, the air diffuser tube inlet 41 and the air manifold inlet 51 are sized appropriately to accommodate maximum volumetric capacity from the pressurized air source 120. The air diffuser tube inlet 41 and air manifold inlet 51 can be setup to accommodate any connection type necessary inside a particular application.

The acceleration chamber 20 features a rapidly decreasing cross-sectional area across the length of the chamber to increase the velocity of the fluid moving through the chamber toward the entrance to the deceleration chamber 30. The acceleration chamber 20 outlet is sized appropriately to not restrict maximum flow from the water pressure source 70. The acceleration chamber 20 also accommodates the air diffuser tube 40 which will be described further herein. The existence of the air diffuser tube 40 inside the acceleration chamber 20 further decreases the cross-sectional area available for fluid to pass through, further increasing velocity.

The deceleration chamber 30 entrance immediately transitions from the small cross-sectional area of the acceleration chamber 20 outlet to a cross-sectional area at least as large as the entry chamber 10. This immediate transition makes the fluid passing through the acceleration chamber 20, traveling at a high velocity readjust to the larger cross-sectional area of the deceleration chamber 30. This pressure and velocity readjustment, along with the introduction of pressurized air from the air manifold 50 wrapping the acceleration chamber and the air diffuser tube 40 creates a turbulent environment of swirling fluid where the water/soap concentrate decelerates and the air and water/soap concentrate pressures equalize creating foam bubbles. This pressure and velocity readjustment and mixing will be described further herein.

The air diffuser tube 40 enters the device at a shallow angle into the entry chamber 10 which allows the flow of water/soap concentrate to adjust around the air diffuser tube 40. The diffuser tube 40 is centered inside the acceleration chamber 20, exiting at the entrance into the deceleration chamber 30. The size of the air diffuser tube 40 is dependent on the maximum volumetric capacity of the air pressure source 120 and the necessary air to water/soap concentrate ratio required. The diffuser tube 40 exit is formed in the shape of an “X” to disperse the pressurized air stream into the center of the water/soap concentrate flow into the deceleration chamber 30. The “X” shaped exit is not the only method which could be used for the dispersing and embedding of pressurized air into the center of the water/soap concentrate. Other possible center tube exit 42 setups could include but are not limited to a flattened tube exit or a round tube with exit holes around the perimeter as required for the application. The tube 40 exits in the same direction as the water/soap concentrate flow. Pipe or hose (not shown) is connected to the manifold inlet 41 to direct pressurized air from the source 120 into the tube 40.

The air manifold 50, which wraps around the acceleration chamber 20, features multiple air apertures 52 around the outside of the deceleration chamber 30 entrance for pressurized air exit into the water/soap concentrate flow. The number and size of these air apertures 52 is dependent on the maximum volumetric capacity of the air pressure source 120 and the air to water/soap concentrate ratio required. The apertures 52 are angled sharply towards the center of the water/soap concentrate stream lacing the water/soap concentrate flow with pressurized air. The air apertures 52 are only present exiting into the deceleration chamber 30. There are no apertures 52 exiting into the entry 10 or acceleration 20 chambers. Pipe or hose (not shown) is connected to the manifold inlet 51 to direct pressurized air from the source 120 into the manifold 50.

### OPERATION DURING FOAM PRODUCTION

Pressurized water/soap concentrate enters the device at the entry chamber 10. Simultaneously, pressurized air is pumped into the device at the air diffuser tube inlet 41 and the air manifold inlet 51 which wraps around the acceleration chamber 20. Water/soap concentrate flows around the entrance of the air diffuser tube 40 and into the acceleration chamber 20. Upon entering the acceleration chamber 20, the water/soap concentrate is squeezed into an ever decreasing cross-sectional area spanning the length of the acceleration chamber 20. This causes the water/soap concentrate to increase in velocity to maintain the same flow rate through the device.

When the water/soap concentrate reaches the entrance to the deceleration chamber 30, the cross-sectional area immediately transitions to at least the size of the entry chamber 10. This immediate transition from a small area to a larger area causes an extreme pressure volatility and velocity decrease in the water/soap concentrate in the deceleration chamber 30. At the same instant, pressurized air from both the air manifold 50 wrapping the acceleration chamber 20 and the air diffuser tube 40 is being introduced into the fluid flow at the entrance to the deceleration chamber 30 causing a swirling action. The air diffuser tube 40 diffuses and embeds pressurized air in an “X” formation into the center of the water/soap concentrate flow. Pressurized air exits the air manifold 50 at the apertures 52 lacing the outside perimeter of the water/soap concentrate flow. FIG. 1 simulates the flow pattern and mixing of the air and water/soap concentrate inside the device.

The inventor believes the mixing (or scrubbing) of the air and water/soap concentrate happens as the result of three operations happening at the same instant inside the deceleration chamber 30. The device is not, however, limited to this theory of operation. These three operations are as follows:
1. The extreme pressure volatility and decrease in velocity of the water/soap concentrate combined with the multiple introduction points of pressurized air inside and outside the water/soap concentrate stream causes the pressures to equalize and adjust to a new pressure allowing foam bubbles to form.
2. The entrance of pressurized air into the water/soap concentrate at multiple locations inside and outside the water/soap concentrate flow combined with the immediate transition from high velocity to low velocity creates a turbulent environment of swirling fluid inside the entrance to the deceleration chamber 30 forcing the mixture of the air and water/soap concentrate.
3. As the water/soap concentrate flows past the pressurized air outlets 42 and 52 inside the deceleration chamber 30 entrance at high velocity, the much heavier water/soap concentrate molecules pull the pressurized air molecules along with them further into the deceleration chamber 30. This pulling of the air molecules with the water/soap concentrate molecules and the turbulent environment created by the forced pressure readjustment causes the air and water/soap concentrate to mix.

The CAF solution then passes through the piping of the delivery system (not shown), through a length of hose and finally through a nozzle for application. No additional piping or hose length is required to mix the CAF once the solution exits the deceleration chamber 30.

The air to water/soap concentrate ratio of the CAF mixture can be adjusted as desired for the application via the valve 100 or via the water pressure source 70 or air pressure source 120 as shown in FIG. 4. The farther open the valve 100, the more water/soap concentrate allowed to enter into the entry chamber 10 if the incoming water/soap concentrate pressure and air pressure are static. The higher the percentage of water/soap concentrate, the wetter the CAF solution is upon exiting the deceleration chamber 30. If the valve 100 is only cracked open and very little water/soap concentrate is allowed to enter into the entry chamber 10, the resulting CAF exiting the deceleration chamber 30 will be very dry. The same effect can be achieved by decreasing the water pump pressure 70. If the water/soap concentrate pressure is decreased and the air pressure is static, the CAF will become dry. Similarly, if the air pressure is decreased and the water/soap concentrate pressure is static, the CAF will become wet.

While adjusting the water pressure source 70 or the air pressure source 120 also allows for adjustment from wet to dry, using the valve 100 and regulating the water and air pressure at the sources, 70 and 120, is the preferred method of changing consistency. This simple method of adjustment allows for infinite possible CAF consistencies within the mechanical constraints of the device. The inventor believes that the acceleration and deceleration of flow and unique introduction of pressurized air at both the perimeter and the center of flow inside deceleration chamber 30 entrance the causes the production of a high quality foam across a wide range of inlet solution water and air pressures.

The mixing device is also capable of operating in “full flow” mode when the pressured air source 120 and/or the soap injection system 90 are deactivated. This allows plain water or water/soap concentrate to flow through the device without pressurized air introduction for scenarios where CAF is not preferred.

Experiments performed by the inventor confirm the successful operation of the device described herein. While the present device is defined with reference to CAFS firefighting equipment, it should be understood by those skilled in the art that the invention is not limited as such. The invention finds application wherever it is desirable to produce a high quality mixture of gas and one or more liquids.

As used herein, “comprising” is synonymous with “including”, “containing” or “characterized by” and is inclusive or open-ended and does not exclude additional, unrecited elements or method steps. As used herein, “consisting of” excludes any element, step or ingredients not specified in the claim element. As used herein, “consisting essentially of” does not exclude materials or steps that do not materially affect the basic and novel characteristics of the claim. Any recitations herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof but it is recognized that various modifications of size, shape, material, inlet and outlet connections or otherwise are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Thus, additional embodiments are within the scope of the invention and within the following claim.

In general, the terms and phrases used herein have their art-recognized meaning, which can be found by reference to standard texts, journal references and contexts known to those skilled in the art. The preceding definitions are provided to clarify their specific use in the context of the invention. All references cited herein are hereby incorporated by reference to the extent that there is no inconsistency with the disclosure of this specification.

All patents and publications mentioned in the specification are indicative of the levels of skill of those skilled in the art to which the invention pertains. The present invention has been described with reference to certain preferred and alternative embodiments that are intended to be exemplary only and not limiting to the full scope of the present invention.

### BACKGROUND OF THE INVENTION

Compressed air foam systems (CAFS) are used in firefighting applications. CAFS are simply a means for mixing compressed air and water/soap concentrate in order to produce a water-based foam that is used to extinguish fires. Compressed air foam (CAF) provides a quicker knockdown than plain water or water/soap concentrate because it attacks all three sides of the fire triangle (fuel, oxygen, heat) by:
Coating the fuel, thus cooling it below the temperature for combustion.
Blanketing the fuel, separating it from oxygen required to keep it burning.
Cooling a superheated environment by creating steam with the entrance of water-based foam.
Blanketing the fuel, preventing outgassing of burning materials.

Another advantage that CAF has over plain water is that water damage and runoff is dramatically decreased. For instance if there is a fire in the attic of a structure, the water used to put out the fire that has not evaporated or turned to steam will seep down into the parts of the structure below the attic. This water damage may end up being more severe than the damage caused solely by the fire. CAF is a foamy solution which does not run as quickly as plain water, depending on the consistency. A very dry CAF will stay in place like a blanket for hours whereas a very wet CAF may runoff in a matter of minutes. Additionally, because CAF is a water/soap concentrate and air mixture it by definition does not contain as much plain water per unit volume as plain water while maintaining a much greater suppression capability.

CAFS can deliver a range of useful consistencies, from very dry to very wet by controlling the air to water/soap concentrate ratio. Very wet CAF is often used for initial attack to immediately cool the fuel and atmosphere. Dry CAF has a very long drain time—the bubbles do not burst and lose their water quickly which is effective when used as a blanket to separate the fuel from oxygen, to protect exposed fuel from advancing fire and to prevent outgassing of the superheated materials.

CAF bubble structure is significant for its ability to be used effectively. The mixing of air into a soapy water concentrate allows for the formation of bubbles which have a significantly greater surface area of water cooling agent, allowing for greater heat reduction versus equal amounts of water. A mix with smaller bubbles has more surface area for cooling agent than a mix with large bubbles, thus it is preferred to achieve a homogeneous mix with very small bubbles for maximum effectiveness. A good CAF mix could be described as resembling shaving cream. CAFS can be particularly valuable for fire departments because the use of foam reduces the amount of water required to extinguish a fire in areas where water sources may be limited or nonexistent as well as allow for less manpower to achieve a quick knockdown of the threat prior to the arrival or more equipment and personnel. CAF is estimated to be superior for fire knockdown by a factor of 10. 400 gallons of water made into CAFS can extinguish roughly as much fire as 4000 gallons of plain water with the same size pump and equipment.

In order for CAF to be created and mixed (known as scrubbing) thoroughly, the water/soap concentrate and air pressures must be equal. This has been a problem for many CAFS manufacturers because they have incorporated balancing valves, pressure regulators and manual adjustments or other electronics to achieve the precise pressures for mixing. Relying on these types of components or human interaction with the system to make it work correctly, introduces more potential failure points and creates a troubleshooting nightmare. Many such CAFS require minimum hose lengths for additional scrubbing so that the correct CAF texture is achieved at the nozzle. Often times, CAFS, due to the complex plumbing and components or flow restrictions, are not capable of flowing plain water without air injection for scenarios where it is preferred to use water or water/soap concentrate only. This requires the apparatus to have a separate plumbing system for CAF only. For these reasons, CAFS has gained a bad reputation in firefighting for being extremely unreliable, not user-friendly and expensive.

For the aforementioned reasons, it is desirable to develop a system which:
Successfully introduces compressed air into water/soap concentrate flow via mechanical means and the principles of physics
Mixes the water/soap concentrate and compressed air to create an ideal bubble structure prior to exiting the device
Has limited moving parts and requires minimal maintenance
Allows for plain water or water/soap concentrate to pass through at maximum flow with the compressed air system and/or soap injection system deactivated.
Allows for easy mechanical adjustment of the air to water/soap concentrate ratio for wet to dry adjustment.

### BRIEF SUMMARY OF THE INVENTION

This invention, when installed with necessary components for a complete CAFS, provides full CAF capabilities with controllable consistency and a high flow rate and can deliver maximum plain water or water/soap concentrate flow when the air supply and/or soap injection system(s) are deactivated.

It consists of three chambers—an entry chamber, acceleration chamber and deceleration chamber, positioned in that order with an air manifold wrapping the acceleration chamber and air diffuser tube at the center of the entry and acceleration chambers, exiting into the deceleration chamber. The air manifold features several angled apertures evenly distributed around the entrance to the deceleration chamber which direct pressurized air flow lacing the water/soap concentrate flow entering the deceleration chamber. The central air diffuser tube functions to embed pressurized air into the center of the water/soap concentrate in the same direction as flow at the entrance of the deceleration chamber. When the water/soap concentrate decelerates and pressurized air laces the perimeter and is embedded in the center of the water/soap concentrate flow inside the deceleration chamber, a turbulent swirling environment is created and the water/soap concentrate and air pressures are equalized which causes the formation of foam bubbles.

These and other features, components and advantages will be better understood in the following detailed description and drawings.

### BRIEF DESCRIPTION OF THE ATTACHED DRAWINGS

FIG. 1 is a sectional view of the entire device to show flow pattern and function

FIG. 2 is a sectional view of the deceleration chamber looking towards the acceleration chamber

FIG. 3 is an assembled top view of the entire mixing device (device shown is circular but the shape can be adjusted to meet particular application requirements)

FIG. 4 is a schematic of an entire CAFS to show how the mixing device is employed with other components

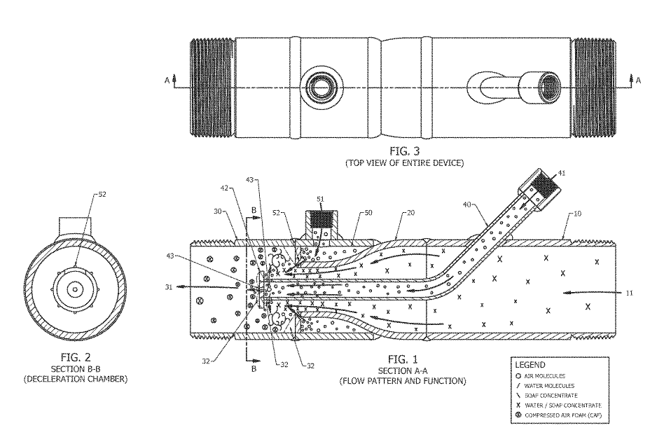

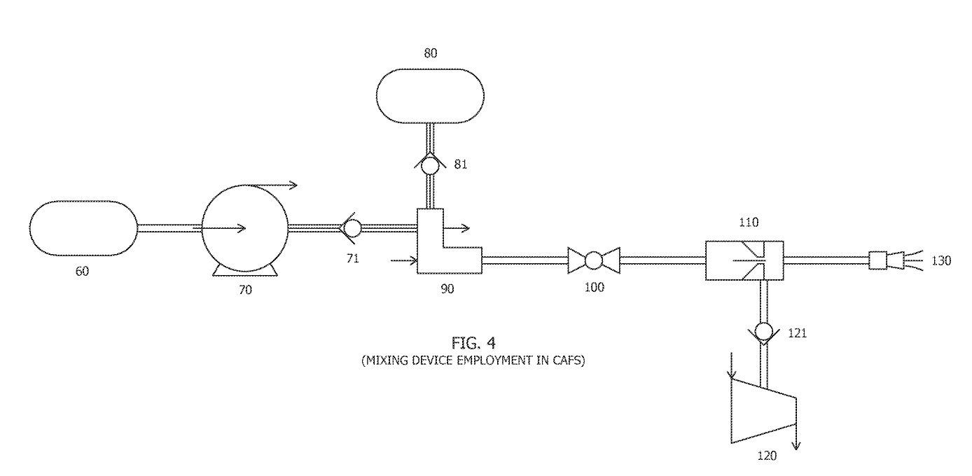

Item 10: Water/soap concentrate entry chamber

Item 11: Variable water/soap concentrate flow and pressure via valve

Item 20: Acceleration chamber

Item 30: Deceleration chamber

Item 31: CAF exiting the mixing device

Item 40: Air diffuser tube in the center of the acceleration chamber exiting into the deceleration chamber

Item 41: Regulated air pressure from compressor inlet

Item 50: Air manifold wrapping acceleration chamber

Item 51: Regulated air pressure from compressor inlet

Item 52: Air apertures from the air manifold wrapping the acceleration chamber exiting into the deceleration chamber (multiple holes distributed evenly)

Item 60: Water source

Item 70: Water pressure source

Item 71: Check valve preventing back flow to water pressure source

Item 80: Soap source

Item 81: Check valve preventing back flow into soap reservoir

Item 90: Soap injection system

Item 100: Valve for adjusting flow and pressure into the mixing device

Item 110: CAF mixing device

Item 120: Air pressure source

Item 121: Check valve preventing back flow into the air pressure source

Item 130: Hose and straight bore nozzle

1. A device for creating compressed air foam (CAF), comprising of:
a. A large cross-sectional area water/soap concentrate entry chamber
i. A valve to control water/soap concentrate flow and regulate pressure from the source into the entry chamber
b. An acceleration chamber with rapidly decreasing cross-sectional area immediately following the large cross-sectional area entry chamber
c. A deceleration chamber with instant change from the small cross-sectional area outlet of the acceleration chamber to large cross-sectional area
i. The small inlet at the deceleration chamber entrance is sized so as not to limit maximum flow through the device from the water pressure source
ii. The large cross-sectional area of the deceleration chamber is equal to or larger than the cross-sectional area of the entry chamber
d. An air manifold which wraps around the acceleration chamber
i. An air inlet with regulated pressurized source on the exterior of the manifold
ii. Multiple air apertures positioned around the manifold into the deceleration chamber, directed into the water/soap concentrate flow
1. Apertures are aligned at a sharp angle to intercept the entire outer perimeter of the water/soap concentrate flow where the water/soap concentrate enters the deceleration chamber
2. Aperture number and size is dependent on the maximum volumetric capacity of the pressurized air from the source
e. An air diffuser tube in the center of the acceleration chamber
i. An air inlet with regulated pressurized source attached to the tube on the exterior of the device
ii. A tube which extends into the deceleration chamber with an end flange to cause turbulence in the center of the flow column of water/soap concentrate
iii. A tube with apertures near the end flange that exit outwards into the center of water/soap concentrate flow
iv. A tube with an aperture exit at the center beyond the end flange directed in the same direction as water/soap concentrate flow
v. A tube with an end flange which creates areas of vacuum near air aperture exits to cause a swirling mixing action of the water/soap concentrate flow and air
f. Pressurized air source inlets are of equal size at both the manifold wrapped around the acceleration chamber and central air diffuser tube
g. The cross-sectional shape of the device chambers is not limited to a circle but may be an oval, square, rectangle, etc. as is determined best for the application
h. No moving parts
